(19) United States
(12) Patent Application Publication
(10) Pub. No.: US 2002/0116518 A1
(43) Pub. Date: Aug. 22, 2002

(54) Fast environment detection and selection of optimized media

(76) Inventors: Bradley A. Silen, Mill Valley, CA (US); Timothy J. Smith, San Jose, CA (US); Alan Peters, San Francisco, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/059,879

(22) Filed: Jan. 28, 2002

Related U.S. Application Data
(60) Provisional application No. 60/266,091, filed on Feb. 1, 2001.

(51) Int. Cl. G06F 15/16

(52) U.S. Cl. 709/231; 709/234

(57) ABSTRACT

A streaming media presentation system is described. The system employs a fast method to detect a plurality of aspects about the operating environment, including bandwidth, and selects a media presentation optimized to afford the best user experience based on a plurality of streaming characteristics. The detection method is a staged method, which improves speed. In response to detected capabilities (e.g., bandwidth), the system selects an optimal stream with particular quality characteristics suited to the detected capabilities, including such features as frame rate, sharpness and frame size. The system is adaptable to existing systems that provide multiple versions of streaming presentations, whether currently automated or dependent upon user selection.

### REFERENCE TO RELATED APPLICATIONS

This application claims priority benefit under 35 U.S.C. §119(e) to provisional patent application No. 60/266,091, filed Feb. 1, 2001.

### FIELD OF THE INVENTION

The present invention relates generally to streaming media, and more particularly to detecting capabilities and selecting media presentation from among a plurality of streaming characteristics to optimize the user experience.

### BACKGROUND AND SUMMARY OF THE INVENTION

There is a growing number of Internet streaming technologies, which are being developed to provide a broadcast type radio or television experience. These technologies employ a variety of techniques to deliver the highest quality experience possible over transport media which are not able to deliver a signal as rich as the television experience the users expect. The transport media will continue to grow in speed. The ability to deliver an ever richer signal will continue to be important even after current television broadcast rates are attained, since there is both continuing pressure to increase signal quality and a growing trend to expand the viewing and interactive experience, including increasing back channel communication with information related to the primary experience.

A vendor committed to present the richest possible experience is motivated to build an open standards technology, which is able to leverage the best technologies available in assembling the final end user experience.

Maximizing the end user experience is further complicated by the fact that each user can have a combination of open standard technologies, which make up their viewing environment. These can include an Internet connection limited to a certain upload and download speed. The viewing environment is also partially defined by an Internet viewer that might include any number of the World Wide Web browsers. Such browsers may be widely used but they currently do not adhere to industry standards and are complex enough to have different defects that affect the viewing experience. The viewing environment is also partially defined by one or more of a growing number of streaming technologies, each of which has its own advantages and limitations.

Realnetworks.com™ has partially addressed this problem by developing their SureStream™ technology, which has the ability to change the bandwidth of the streamed experience without interruption. This technology, however, is limited to having a single height and width viewing area and does not include the ability to change the size of the experience as an additional means to respond to bandwidth changes. This solution is also limited to presenting only the vendor's own technology and not leveraging technologies of other vendors.

The methods described herein, in contrast, analyze the end user's operating environment and select the best combination of technologies to present an immediate and rich experience optimized based on the available bandwidth. The environment characteristics analyzed and adjusted include but are not limited to the manufacturer and version number of their viewing environment, screen resolution, operating system, installed streaming technologies, and bandwidth.

The bandwidth detection portion of the described system is advantageously able to obtain a precise measurement of the end user's bandwidth in less than 10 seconds, and more preferably less than 5 seconds. Other detection mechanisms inspected can take as long as 2 minutes on a 28.8 MBit modem, which is an industry standard. It has been studied and shown that users of the World Wide Web will on average not wait more than 8 seconds before abandoning their attempt to view a site and moving to some other activity. For these reasons, other vendors have selected to not offer automatic bandwidth detection and instead choose to force the user to interrupt the viewing experience to select a bandwidth. This manual process is often confusing to many users who do not know their connection speed and adds an additional technology barrier between the user and the free flow of content.

While users are watching a presentation at a selected bandwidth, the sustainable bandwidth can increase and decrease dynamically. Since many open standard streaming technologies have no means to respond to this bandwidth change, the end user is not able to benefit by the increased bandwidth or respond automatically to what will become a choppy and poor experience when bandwidth drops. Once the presentation is started, the system described herein repeatedly queries the streaming player for the current bandwidth being presented. If certain configurable thresholds are achieved it will momentarily stop the presentation and make a plurality of adjustments, such as loading a different medium, resizing the presentation if required, seeking the point were the presentation was stopped in the new stream and continuing the presentation.

In accordance with one aspect of the present invention, a staged method of detecting bandwidth capabilities over a network is provided. In the preferred embodiment, the method includes conducting a first bandwidth test by downloading a small package. If the download time is small compared to the timer resolution, a second bandwidth detection is conducted using a larger package of information to thereby lengthen the download time to one that can be accurately measured under the available timer resolution.

In accordance with another aspect of the invention, a method is provided for optimizing streaming video across a network. The network includes detecting bandwidth capabilities at a terminal on the network, and adjusting a presentation frame size based upon the detected bandwidth.

In accordance with another aspect of the invention, a generalized system is provided for delivering streaming data to a client on a network. The system includes a detection mechanism configured to automatically select from a plurality of available information streams for a given presentation. In the preferred embodiment, the detection mechanism is initiated before the presentation is selected for streaming. Moreover, detection is preferably also conducted dynamically during a presentation.

### BRIEF DESCRIPTION OF THE DRAWINGS

These features and other will be better understood by the description below and the appended figures, which are meant to illustrate and not to limit the invention, and in which:

FIG. 1 is a flow chart illustrating a method in accordance with a preferred embodiment of the present invention, representing a state machine that is implemented on a client browser.

FIG. 2 is a continuation of the flow chart of FIG. 1.

FIG. 3 schematically illustrates elements involved in the method of FIGS. 1 and 2.

### DETAILED DESCRIPTION OF THE PREFERRED EMBODIMENT

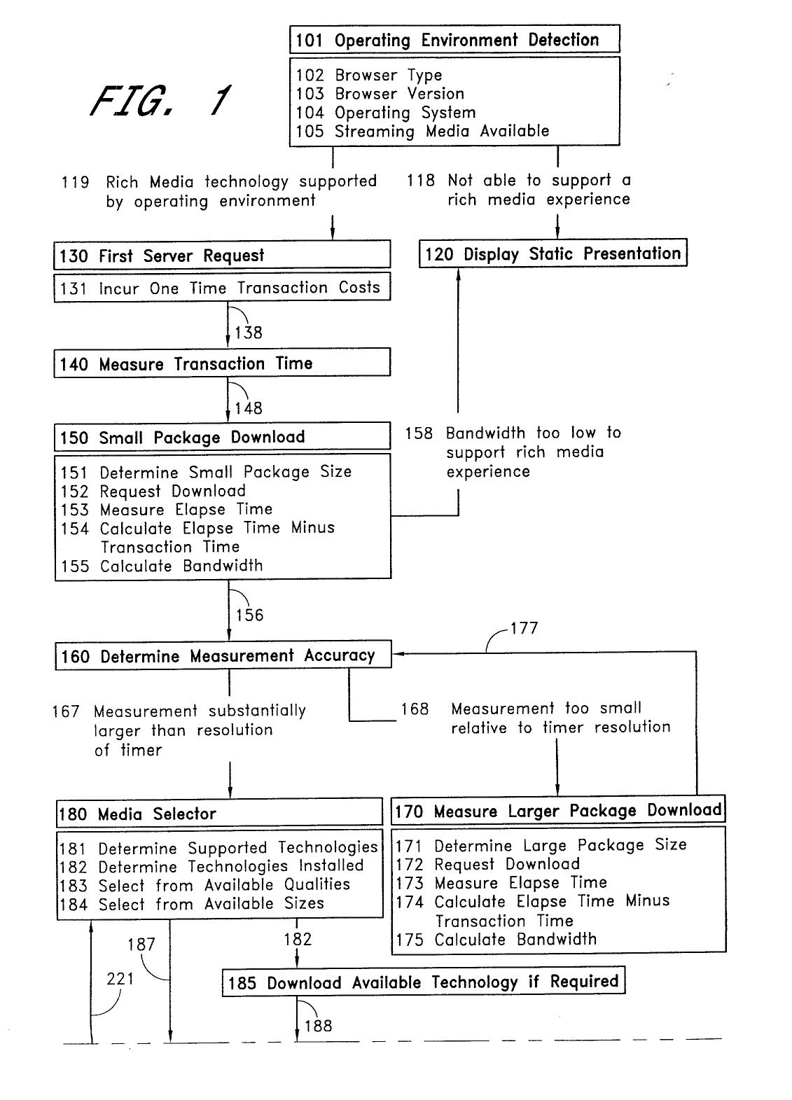

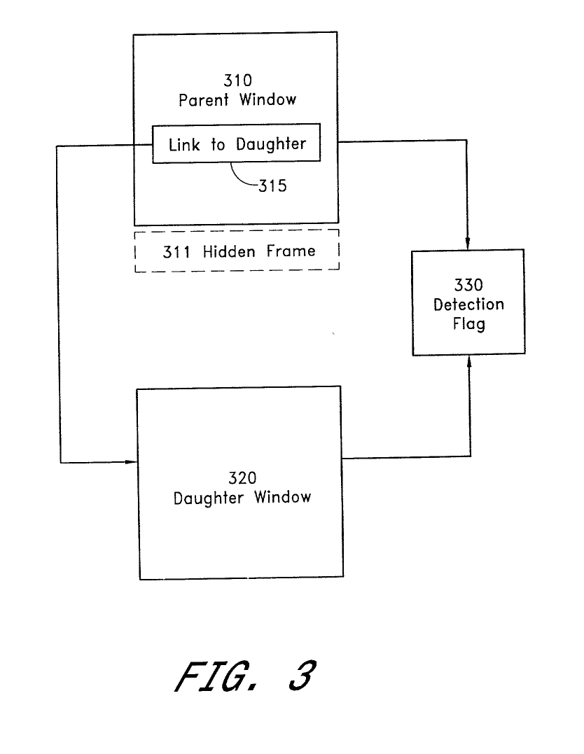

With reference to FIG. 3, the preferred embodiment of this invention is implemented in a network browser, and particularly in a World Wide Web browser. The user experience can include, but is not limited to, navigating to a parent window 310, which is presented as a traditional Hypertext Markup Language (HTML) presentation that presents a button or link 315 to initiate a rich media experience in a daughter window 320. The button or link that opens the daughter window 320 initiates the environment detection and selection of optimized media to present. An alternate embodiment embeds code in the parent window 310 for initiating the processes described hereinbelow, which leverages the time a viewer spends reading the contents of the parent window 310 and activating the rich media experience window 320. An Operating Environment Detection 101 (FIG. 1) starts during the time a viewer spends reading the contents of the parent window 310 to produce the most immediate response, once the user has selected viewing the daughter window 320, which contains the rich media experience. This detection can be done using a variety of techniques to obtain an execution thread in the context of the parent window 310. One technique utilizes HTML FRAMESET to present the traditional Hypertext Markup Language (HTML) presentation that resides in the full viewing area 310 with a second hidden FRAME 311 to run the detection mechanism 330 and save the result without affecting the user experience.

For historical reasons, some operating environments do not allow the use of FRAMESETS so the execution thread can be obtained by creating a state machine of events in the parent window 310 that are triggered by OnLoad™ handlers which are built into the event model of current web browsers.

The Operating Environment Detection 101 involves first determining the browser type 102, browser version 103, operating system 104 and streaming media 105 that are available in the operating environment. If certain minimum thresholds are not obtained, such that the presentation would not be able to support a rich media experience based on compliant open source streaming technologies available, the user is taken 118 to a nonstreaming or static viewing experience 120 to ensure their access to the information.

On the other hand, if rich media can be supported by the operating environment, the user is taken 119 to a bandwidth detection portion of the system, which begins by requesting 130 the smallest possible image or other information packet to be loaded. The first server request 130 is done to ensure any first time overhead to be completed is done so it does not effect subsequent measurements, since it will incur one-time transaction costs 131 that will not be a recurring factor in the operating environment. This often includes the Domain Name System (DNS) lookup to convert a domain name like “company.com” to an IP address that is used by the communication mechanism for the actual data transmission.

To prevent the first image and all subsequent images from being cached by the display environment or any portion of the transport infrastructure that exists between the end user and the server environment, a random number is preferably appended to the end of the requesting Universal Resource Locator (URL). Such caching is preferably prevented to ensure the bandwidth is being measured rather than measuring the efficiency of the caching technologies.

Once the communication channel is opened by the first server request 130, the state machine invokes 138 measurement of a transaction time 140 between the viewing environment and the server fulfilling the experience. This is measured so it can be subtracted from subsequent measurements 150, 170 such that those measurements include only the bandwidth related information.

The state machine next engages 148 a small package download 150 in order to conduct a first stage bandwidth detection. This module 150 employs an image or other package of information created sufficiently small to be quickly downloaded. The threshold for the “small package” size is selected, in the illustrated embodiment, to ensure it will not take more than about 4 seconds to download using the slowest expected communication mechanism. Note that different package sizes can be selected for different implementations of the described methods. The module 150 determines the size of the small package 151, requests the package 152, measures the elapse time 153, calculates the elapse time minus the transaction time 154 and then calculates the bandwidth 155. The bandwidth is computed 155 by dividing the measured small image size (in bits) by the elapse time. The data in the package that is downloaded 150 has preferably been created to ensure its contents are random enough to not be substantially compressible.

If the calculated bandwidth 155 is too low to support a rich media experience, the user is taken 158 to a nonstreaming or static viewing experience 120 to ensure their access to the information.

The small package response time minus the transaction time 154 is then tested to determine measurement accuracy 160. If the measurement is determined substantially larger than the resolution of the timer, program flow will then transition 167 to the Media Selector 180.

If the calculated 154 small package response time minus the transaction time gives measurements too small, relative to the timer resolution, a second stage detection employing a larger package download 170 is invoked 168 to measure a larger package. This package is selected to take no longer than about 3 seconds to download using the next faster commonly deployed network equipment, i.e., the next increment faster than a commonly deployed network equipment that is defined as one able to read previous or small package in less than 2 seconds. In other words, since the earlier bandwidth calculation 155 found the equipment too fast for the resolution of the timer, the equipment is assumed to be faster in selecting the approximate size of the package for purposes of the second stage bandwidth detection 170. Once the larger package size is determined 171, the download is requested 172, the time of the download is measured 173 and the elapse time minus the transaction time is computed 174. The size of this large package is then divided by the [response time minus the transaction time] to determine the speed 175 of a high bandwidth connection with more accuracy. Once the bandwidth is calculated 175 in this manner, the program loops back 177 to allow determination 167 that the measurements are substantially larger than the resolution of the timer, allowing operation of the media selector 180 as described below.

The staged approach of measuring larger packages 170 when the measurement is below a threshold determined by the accuracy of the timer resolution can cascade and be repeated any number of times as the range of possible bandwidths increases, breaking up the sequence into modules for ever larger package sizes to specify higher bandwidths. Thus, if the second bandwidth detection stage finds the bandwidth outside the timer resolution, a third stage can be employed using an even larger package download, etc.

Accordingly, the staged approach starts with a small package such that, if the bandwidth is small, only the time required to download a small package is utilized during the bandwidth detection process. Only if the bandwidth is high are larger packages, which require longer times to download, employed for the bandwidth detection testing. This staged process ensures that time is not wasted in downloading large packages unless the bandwidth is so high that resolution limitations require those larger packages for testing the bandwidth.

Once the bandwidth is detected 155 or 175, it is fed into the Media Selector 180, which determines the technologies supported 181 by and already installed 182 in the client environment, and selects from the available qualities 183 and the available sizes 184. Quality of the rich media experience is based on a plurality of factors, including but not limited to vendor technology, frame rate, sharpness, contrast and screen resolution. If a need is determined 182, available technologies can be downloaded 185.

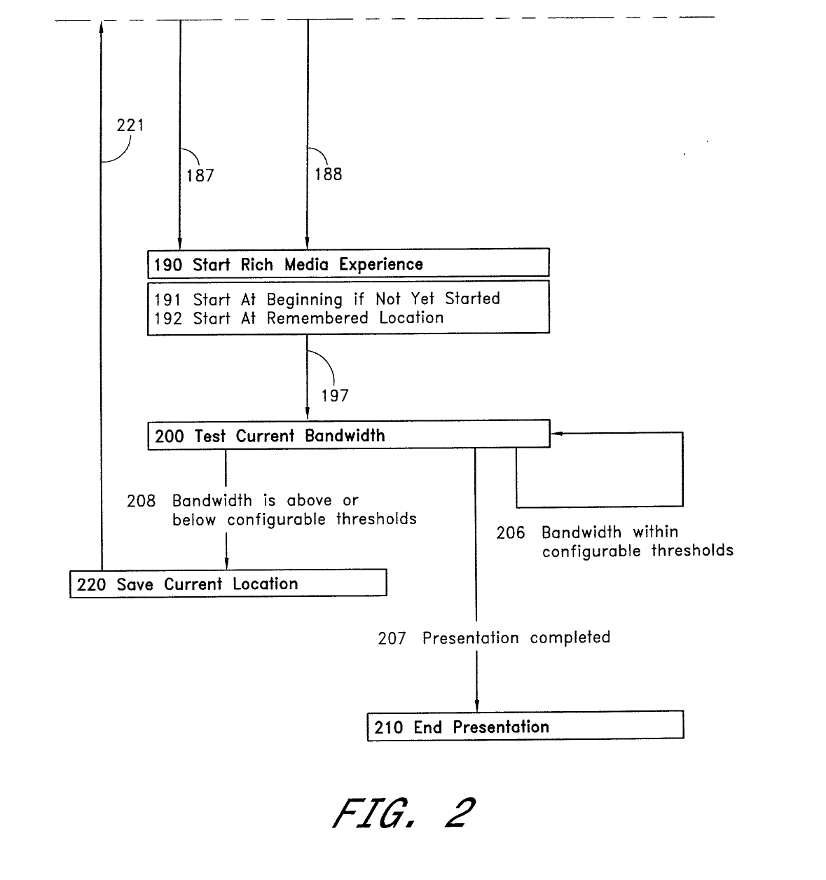

From here, the program continues 187 or 188 to start the rich media experience 190, as shown in FIG. 2. The richest experience based on the available bandwidth is selected by the Media Selector 180 and the rich media experience is started 191. On the other hand, if the rich media experience had already been started, the experience can be started at a remembered location 192 after the streaming had been paused, as will be made more clear from the description below.

With reference again to FIG. 3, if the user chooses to start the media presentation from a parent window 310 that does not have the detection mechanism integrated, the rich media presentation displayed in the daughter window 320 will detect this by a detection flag 330 shared between the windows and undertake the bandwidth detection.

If the user chooses to start the media presentation from a parent window 310 that does have the detection mechanism but has not been able to complete the detection and transition to the media selector 180 before the request to invoke the experience has been requested, the shared flag 330 is utilized as a semaphore to detect this scenario and the daughter window 320 will wait for the parent window 310 to complete the detection so as to leverage the time which has already been spent upon bandwidth detection.

Referring back to FIGS. 1 and 2, once the presentation is started 190, a polling mechanism 200 is invoked 197 using a timer in the operating environment to query the streaming player at regular intervals and determine if the bandwidth is still within configurable thresholds 206, in which case the polling mechanism 200 continues to test periodically. If the bandwidth is detected to be above or below configurable thresholds 208, the current location in the presentation is saved 220 and the newly detected bandwidth is fed 221 into the Media Selector 180. The presentation is restarted 192 at the correct location in the experience using a different presentation media, bandwidth, size and/or other variable parameters. This process continues until completion is determined 207 and the presentation ends 210.

Preferably, the currently sustainable bandwidth is cached 330 so additional presentations can use this information to further the user experience.

Advantageously, the method is adaptable to receiving streaming data from both “smart” systems and “dumb” systems that provide a plurality of streams for a given presentation. “Smart” systems, such as SureStream™, already provide automated detection and selection of stream quality. The methods described herein are adapted to improve detection speeds for such smart systems, and also to provide additional options for responding to the detected bandwidth capabilities. “Dumb” systems currently provide multiple quality characteristics for a given presentation but depend upon manual selection of the stream by the user at the terminal. The methods described herein are adapted to provide automation to this selection of available streams, and also to provide additional options for responding to the detected bandwidth capabilities.

In a particularly advantageous embodiment, bandwidth capabilities can be detected as described herein, or by other equivalent processes, particularly where the bandwidth is continually recalculated if it strays from within a given window. Then, upon starting 191 or resuming 192 the streaming rich media experience, the display frame for video display can be resized for optimal experience.

Although the foregoing invention has been described in terms of certain preferred embodiments, other embodiments will become apparent to those of ordinary skill in the art, in view of the disclosure herein. Accordingly, the present invention is not intended to be limited by the recitation of preferred embodiments, but is instead intended to be defined solely by reference to the appended claims.

We claim:

1. A method of detecting bandwidth capabilities over a network, comprising detecting bandwidth in stages depending upon comparing a conducted detection measurement against resolution limitations.

2. The method of claim 1, comprising:
conducting a first bandwidth measurement employing a small package download;
determining whether the first measured bandwidth is within resolution limitations; and
if the first measured bandwidth is determined to be outside resolution limitations, then conducting a second bandwidth measurement employing a larger package download.

3. The method of claim 2, wherein the small package download is selected to be conducted within no more than about four seconds using the slowest expected communication mechanism.

4. The method of claim 3, wherein the larger package download is selected to take no more than about three seconds using a commonly employed network equipment one increment faster than the slowest expected communication mechanism.

5. The method of claim 2, wherein the first bandwidth measurement comprises downloading a small package, timing the small package download, and first calculating the bandwidth based on the timed small package download.

6. The method of claim 5, wherein determining whether the first measured bandwidth is within resolution limitations comprises determining whether the timed small package download is within timer resolution.

7. The method of claim 5, wherein the second bandwidth measurement comprises:
downloading a larger package;
timing the larger package download; and
second calculating the bandwidth from the timed larger package download.

8. The method of claim 7, further comprising:
determining the small package size prior to first calculating; and
determining the larger package size prior to second calculating.

9. The method of claim 2, further comprising:
determining whether the second measured bandwidth is within the resolutions limitations; and
recalculating bandwidth by downloading a package larger than the larger package.

10. The method of claim 9, further comprising continually recalculating bandwidth using progressively larger package downloads until the calculated bandwidth is within the resolution limitations.

11. A method of optimizing streaming video across a network, comprising:
detecting bandwidth capabilities at a terminal on the network; and
adjusting a display frame size based upon the detected bandwidth.

12. The method of claim 11, wherein detecting bandwidth capabilities comprises conducting a staged bandwidth measurement using progressively larger package downloads until the measured bandwidth is within system resolution limitations.

13. The method of claim 12, wherein the system resolution limitations comprise timer limitations.

14. The method of claim 11, wherein detecting bandwidth capabilities is initiated prior to user initiation of displaying the streaming video.

15. The method of claim 11, wherein detecting bandwidth capabilities is conducted continually during presentation to determine whether detected bandwidth remains within defined configurable thresholds for a currently employed presentation media.

16. A generalized system for delivering streaming data to a client on a network, the system including a detection mechanism configured to automatically select from a plurality of available information streams for a given presentation.

17. The system of claim 16, wherein a detection mechanism is configured to repeatedly measure bandwidth and determine bandwidth measurement accuracy until the measured bandwidth is within system resolution limitations.

18. The system of claim 17, wherein the repeated bandwidth measurements download progressively larger packages and measure elapsed time during the downloads.

19. The system of claim 16, wherein the detection mechanism employs a static presentation if a measured bandwidth is too low to support a rich media presentation.

20. The system of claim 16, configured to initiate bandwidth detection prior to user selection to display the given presentation.
